(19) United States
(12) Patent Application Publication
(10) Pub. No.: US 2006/0011072 A1
(43) Pub. Date: Jan. 19, 2006

(54) Omelet pan

(76) Inventors: John Giornali, Long Beach, CA (US); Kenneth A. Tarlow, Corte Madera, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/889,516

(22) Filed: Jul. 13, 2004

(51) Int. Cl. A47J 37/10

(52) U.S. Cl. 99/422

(57) ABSTRACT

A metal oblong shaped cooking pan having a flat bottom, side walls, a pair of opposing flat flipper members that reside at the left and right sides of the pan bottom, a handle member, the handle member being partially hollow and housing a plurality of gears that terminate in a pair of flipper actuation tabs. The pan bottom includes a centrally located depressed portion. The flat flippers terminate at the boarder of the depressed portion and each have a gear engagement post. One the gear includes a receptacle for removably receiving the flipper engagement post The flippers have a spring biased hinge post making the flippers removable and replaceable. Gears activate a slidable rack and the rack terminates in the flipper activation tab. When the activation tab is pulled a flipping action takes place that makes perfect and omelets or crepes.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cooking utensils and more specifically to an omelet pan.

Metal pans for cooking have been used over heating sources for many hundreds of years. They are traditionally placed over gas burners or electric elements to cook a variety of foods. More recently, cooking pans have been designed for specific cooking applications such as pancake pans and wok pans.

Cooking an omelet presents certain unique challenges because the cook needs to flip a portion of the flat cooked egg over on itself to cover the internal contents of the omelet. During this operation the cook must cleanly brake away the perimeter portion of the flat cooked egg and flip the correct portion of the egg over using a spatula without tearing it.

Herman Furletti, in his patent U.S. Pat. No. 4,773,318, now expired, has designed an omelet pan with a built in spatula being rotatably fixed to the handle of pan. However, there are deficiencies in this design in that it readily transfers heat to the handle portion of the pan. It also has a tendency to trap cooked egg under the spatula member thereby burning that portion of the egg. Additionally, the spatula portion is not easily removable thereby making it difficult to clean. Furthermore, the operation of flipping the egg requires two hands, one to hold the pan handle and the other to flip the spatula handle. Additionally, the Furletti design shows only one spatula flipping member which may be sufficient for making omelets, but is not capable of making crepes which need to be folded on opposing sides. Finally, the flat nature of the overall pan bottom makes it difficult to make room for omelet filling that is normally placed in the central portion of the omelet.

### BRIEF SUMMARY OF THE INVENTION

The primary object of the invention is to provide a cooking pan that allows the user to easily and neatly fold a portion or portions of a cooked flat cooked egg mixture to make a perfect omelet or crepe without the need for a spatula.

Another object of the invention is to provide a cooking pan that allows the user to easily and neatly remove an omelet or crepe from the pan.

Another object of the invention is to provide a cooking pan that includes a centrally located depressed portion that provides a place to add filling to an omelet or crepe.

Another object of the invention is to provide a cooking pan that includes removable flipping portions for easy cleaning.

A further object of the invention is to provide a copper whisk that further improves the quality of an omelet.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an omelet pan comprising a metal oblong shaped cooking pan including side walls. One or more flat flipper members reside at the bottom of the pan. A handle member is partially hollow and houses mechanical force transferring members that terminate in a pair of flipper actuation tabs. The pan includes a centrally located depressed portion for holding the contents of an omelet. The flat flippers conform to the perimeter of the bottom portion of the pan and terminate at the boarder of said depressed portion. Each flipper has an engagement post located at the side of the flipper that is closest to said recessed pan portion. The mechanical force transferring portion includes a receptacle for removably receiving said flipper engagement post. The flat flippers each have a spring biased rotation post parallel to and opposing said engagement post thereby making said flippers removable and replaceable for cleaning purposes. The flat flippers have a major portion of their central area removed so that the cooking omelet resides primarily at the pan bottom and the flipper is frame like so that it has just enough remaining material to flip the omelet. The bottom of the pan includes a plurality of downwardly facing ribs on either side of said depressed portion so that said pan can rest evenly on a standard stove burner. The pan includes a flange about the perimeter of the sidewall that can accept a lid.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a section view of the invention.

FIG. 3 is a top view of the mechanical flipping mean

FIG. 4 is an exploded view of the flipper to pan interface.

FIG. 5 is a perspective view of an omelet spatula

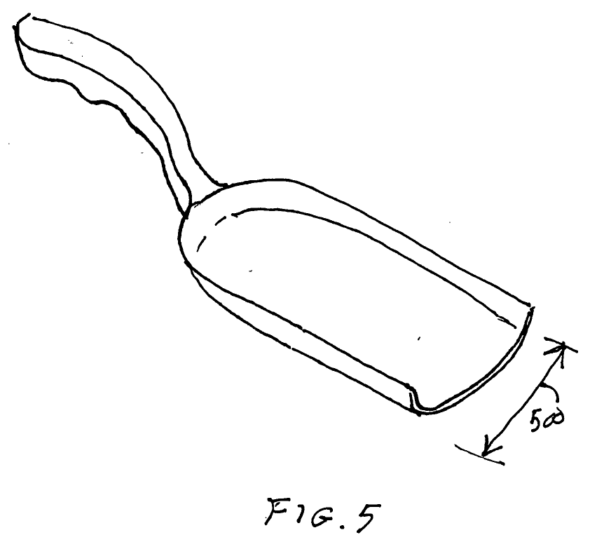

FIG. 6 is a perspective view of an omelet whisk.

FIG. 7 is a perspective view of an alternate pan wall configuration.

FIG. 8 is a top view of an alternate flipping mechanism

FIG. 9 is a perspective view of the pan with lid in place.

FIG. 10 is a perspective view of the pan with a steamer plate in place.

FIG. 11 is a perspective view of the pan with an egg poacher tray in place.

FIG. 12 is a bottom view of the invention.

FIG. 13 is a side view of the invention,

FIG. 14 is a top view of an alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

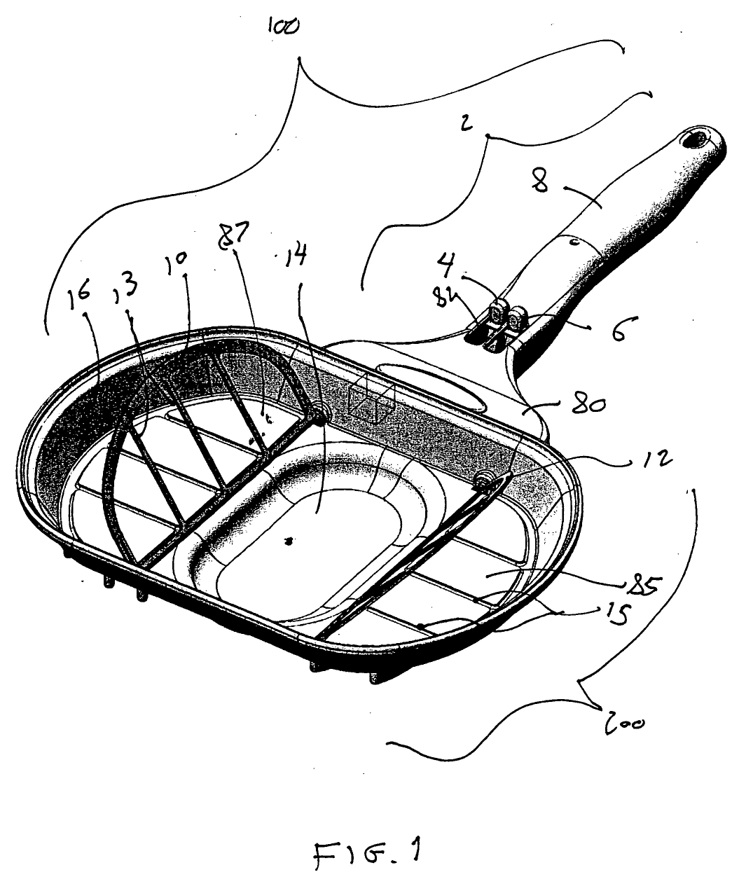

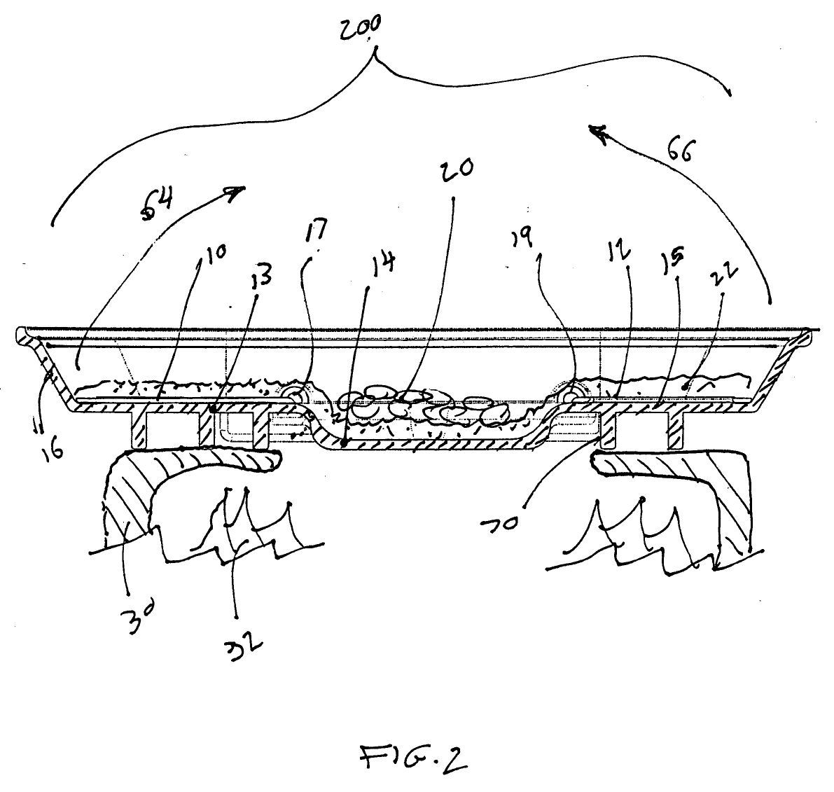

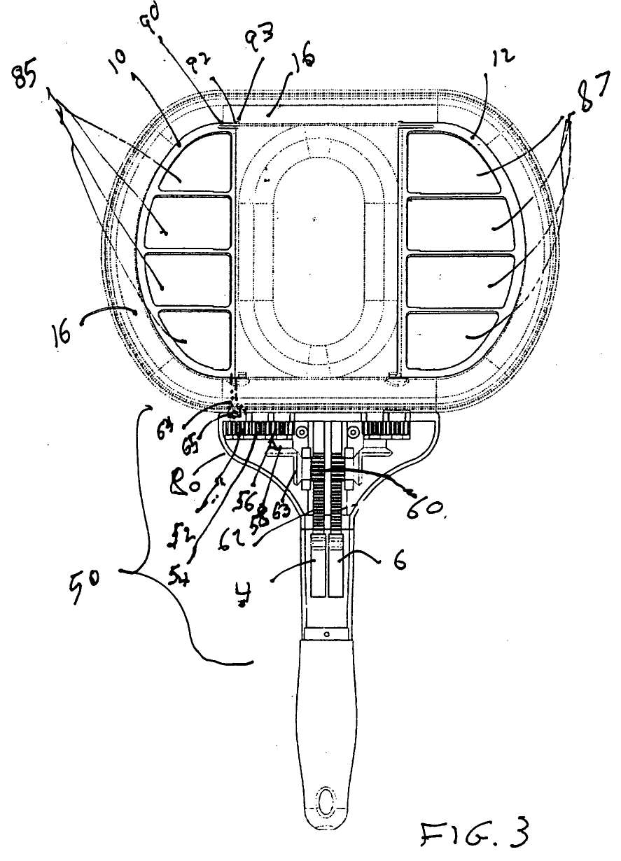

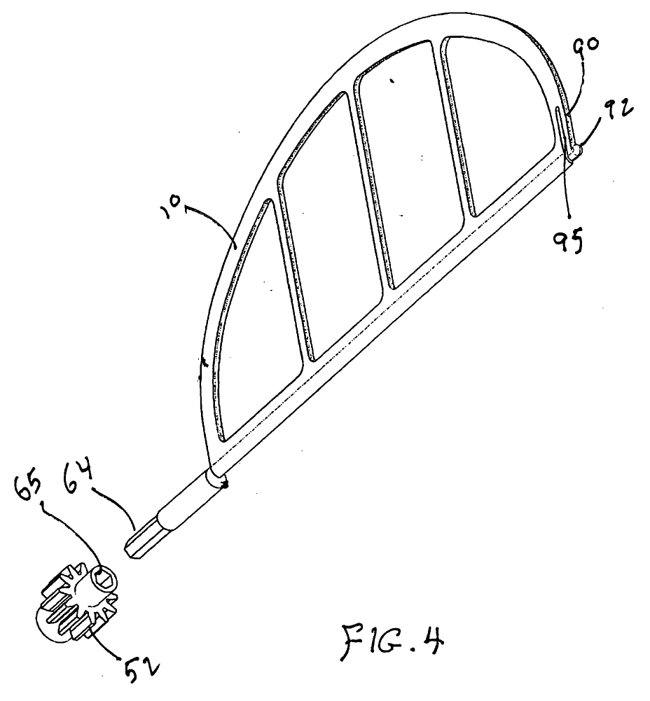

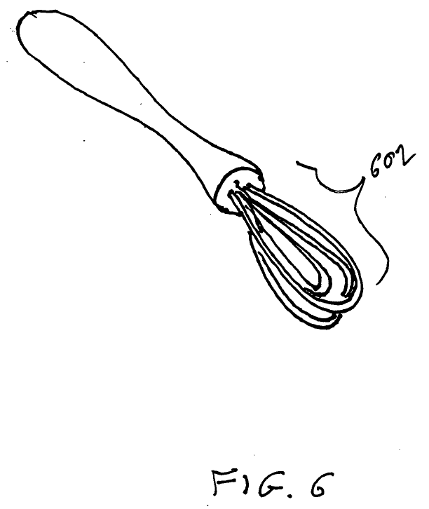

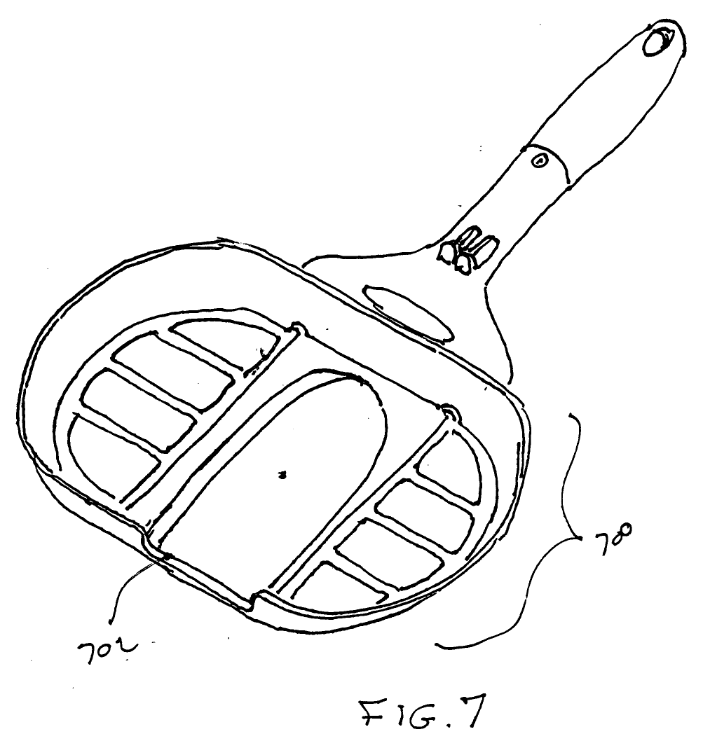

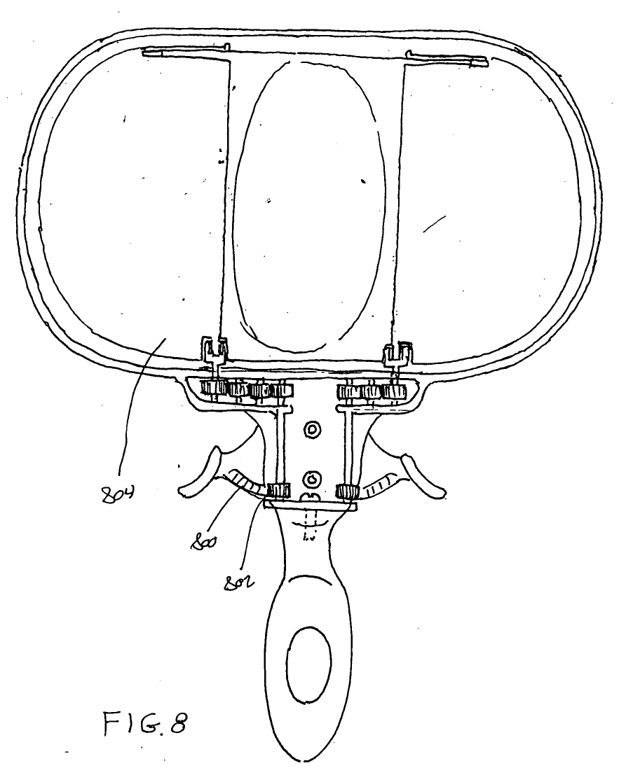

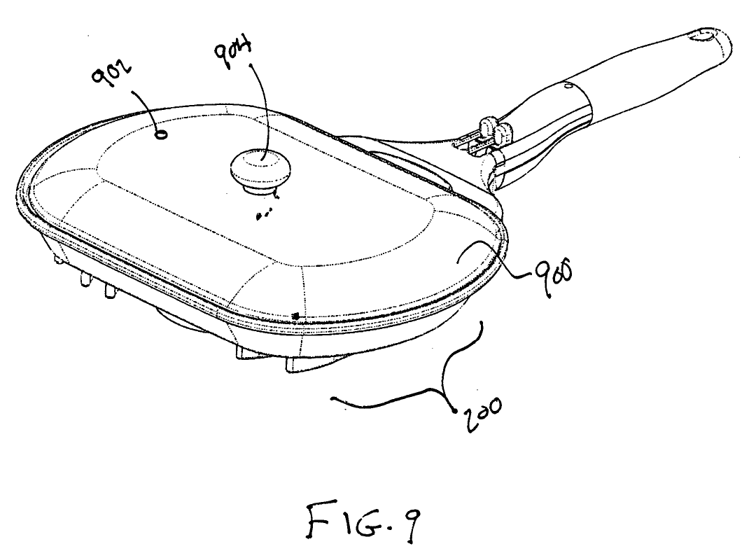

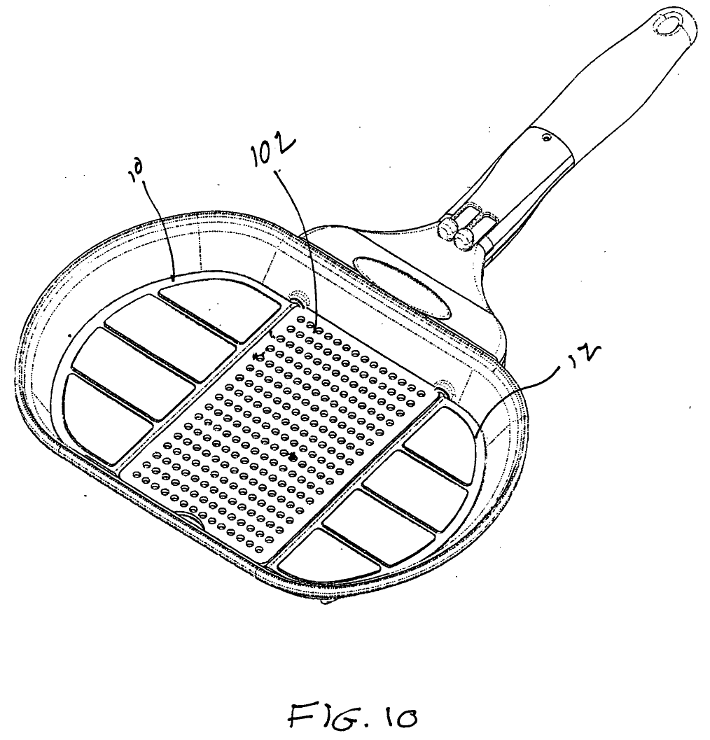

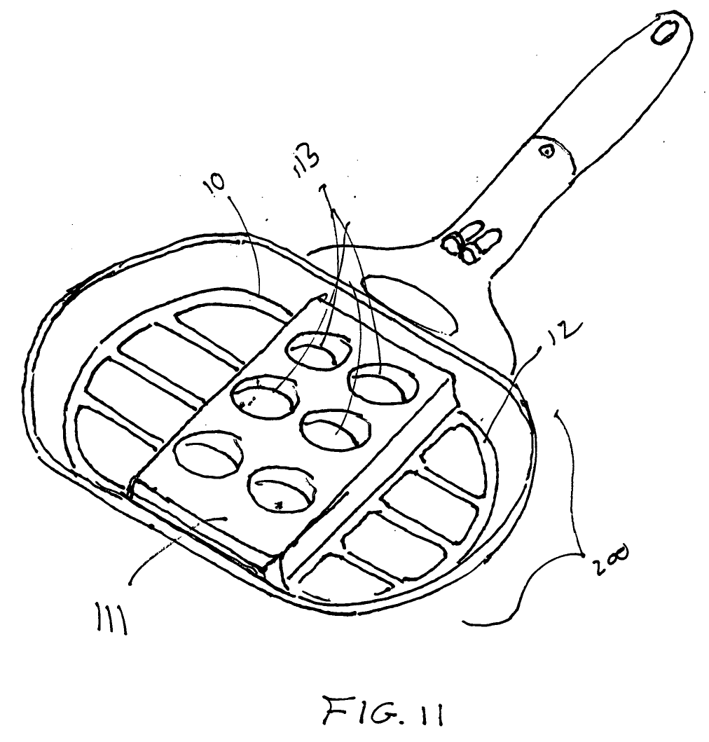

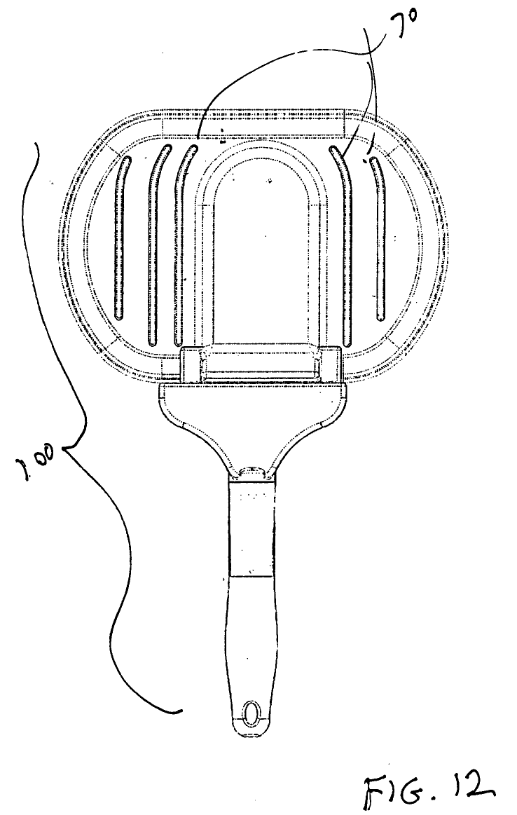

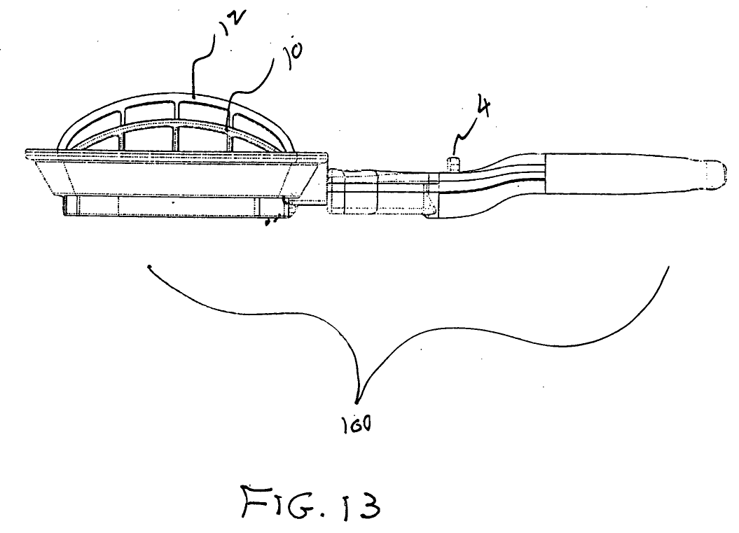

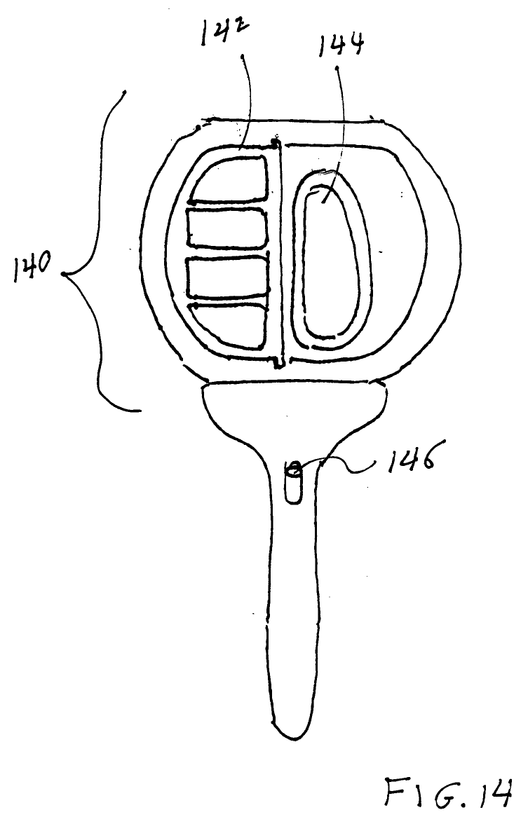

Referring now to FIG. 1 we see a perspective view of the invention 100. The omelet pan consists of a cooking pan portion 200 that has a bottom where the central area is depressed 14 and the right and left bottom side of the pan include flippers 10, 12 shown here in a partially rotated position. The flippers 10, 12 have major cut out areas 85, 87 leaving ribs 13 so that a cooking egg can directly communicate with the pan bottom. The area 80 between the pan assembly 200 and handle assembly 2 includes a mechanical force transference assembly that terminates in actuation tabs 4, 6. When the user pulls back on either of the actuation tabs 4, 6 the respective flippers 10, 12 are caused to rotate thereby producing flipping action. Note that pan bottom 85, 87 includes recesses 15 that allow the flippers 10, 12 to lie within the recesses so that the top plane of flippers 10, 12 is on the same level as the top plane of pan bottom 85, 87. Cutouts 82 in the handle allow actuator tabs 4, 6 to slide unimpeded. FIG. 2 shows a section view of the pan assembly 200. In this view we can clearly see the relationship of flippers 10, 12 to pan bottom comprised of flat portions 13, 15 and depressed portion 14. Points 17 and 19 show the rotation locations that cause flippers 10, 12 to rotate as shown by direction lines 64, 66. Downwardly extending ribs 70 help transfer heat from the cooking surface 30 and associated heat source 32 to the pan bottom. In this view omelet 22 can be seen as well as omelet additives 20. FIG. 3 shows a top view of the invention 100 with the cover of hollow portion of handle 80 removed exposing mechanical transfer assembly 50. Of course, a variation of the present design could include only one flipper rather than two. This variation can be seen in FIG. 8. However, my experiments show that flipping a right and left portion of cooked egg over onto a central cooked portion containing omelet additives such as cheese, vegetables, fruit or meat produces a superior omelet. Additionally, a cook may choose to prepare crepes in this pan 100. Crepes of course generally require the left and right side of the crepe material to be flipped in upon a central area. Referring to FIG. 3 we see that flippers 10, 12 have extensive cut out portions 85, 87 that allow the majority of the omelet to cook directly on the pan surface rather than the flippers 10, 12 themselves. In this way, egg material has less of a chance of becoming trapped between the flippers 10, 12 and the interior surface of the pan 13, 15. Additionally, egg material is cooked more evenly because the heat from the stove does not have to travel through both the pan bottom and the flipper material. FIG. 3 shows one standard mechanical transfer system 50 which causes a pull back on actuation tabs 4, 6 make flippers 10, 12 rotate. In this configuration flipper 10 includes a hex shaped post 64 that removably engages with socket 65 located in first gear member 52. Gear 52 interacts with spur gear 54 which in turn interacts with spur gear 56 which has a miter gear 58 fixedly mounted on a common shaft 59. Mating miter gear 63 if fixedly connected to pinion gear 60. Actuation tab 4 is integral with rack 62 so that when actuation tab 4 is pulled back, the above described gears interact with each other to cause flipper 10 to rotate. A mirror image of gear system 50 if found on the right side of the unit 51 so that pulling back on actuation tab 6 causes flipper 12 to rotate. Other standard mechanical transfer means may be employed to rotate flippers for example, in FIG. 8 a radial rack 800 interacts with a pinion gear 802 to cause the flipper 804 to rotate. Notice also that flipper 804 is solid with no cut outs. This configuration is seen as an alternate but inferior embodiment. FIG. 4 shows, in a partial exploded view, flipper 10 has a hex shaped shaft 64 that can removably engage with socket 65 located in first gear 52. At the opposite end of flipper 10 a shaft member 92 can engage with socked 92 located in the pan wall 16. Cutout area 95 allows remaining metal material 90 to flex so that shaft 92 can snap into aperture 93. The user can remove flipper 10 for cleaning by inwardly flexing metal material 90 and sliding hex shaft 64 from aperture 65. FIG. 6 shows a specially shaped spatula that can easily remove the finished omelet from the omelet pan 100. The width of the spatula as shown by dimension line 500 is the same width of depressed pan area 14. FIG. 9 shows a lid 900 that can be constructed of glass or metal. Vent aperture 902 allows some moisture, in the form of steam, to escape thereby allowing the items cooking in the pan 200 to remain moist but not watery. Knob 904 is made of material that does not easily transmit heat such as phenolic plastic. Lid helps an omelet cook more quickly and evenly. A further alternative embodiment 700 can be seen in FIG. 7 where a cutout portion 702 to pan side wall 16 allows the spatula to more easily enter the pan for even easier and less damaging omelet removal. In this embodiment, the lid 900 would include a downwardly facing filler wall that would fit snuggly into the cut out area 702. FIG. 6 shows a specially designed whisk where the tines of the whisk 602 are made of copper. Copper produces a chemical reaction with egg material that gives the resulting omelet more body and improves flavor. The above description and illustrations show that the present invention comprises a novel and complete system for making perfect omelets or crepes. FIG. 12 shows a bottom view of the invention 100 where downwardly directed heat transfer ribs 70 can be clearly seen. FIG. 10 shows the addition of a steamer plate 102 that fits between the flippers 10, 12. This plate 102 allows the user to fill the depressed area below the plate 102 to be filled with water so that when pan lid 900 is in place the pan 100 can be used as a steamer pan for cooking vegetables, fish and meat. FIG. 11 shows another insert 111 that also fits between flippers 10, 12. The depressions 113 in the insert 111 are sized for making poached eggs. In this configuration, water is placed in the central recess 14 of pan 100 thereby creating a steam effect for proper poaching. FIG. 13 shows a side view of the invention 100 with flippers 10, 12 partially rotated. FIG. 14 shows an alternate embodiment of the present invention 140 where a single flipper 142 can be actuated by actuation tab 146 thereby making a more traditionally shaped omelet. Depressed area 144 helps hold omelet filling as described in the preferred embodiment.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Omelet Pan comprising:
a metal oblong shaped cooking pan including having side walls;
one or more flipper members that reside at the bottom of the pan;
a handle member;
said handle member being partially hollow and housing a plurality of gears that terminate one or more flipper actuation tabs;
said pan including a centrally located depressed portion;
said flat flippers conforming to the perimeter of the bottom portion of said pan and terminating at the boarder of said depressed portion and each having a gear engagement post located at the side of the flipper that is closest to said recessed pan portion;
one said gear including a receptacle for receiving said flipper engagement post;
each said flat flipper having a post parallel to and opposing said engagement post that rotatably engage with a mating aperture located in said pan wall; and
the bottom of said pan including a plurality of downwardly facing ribs on either side of said depressed portion so that said pan can rest evenly on a standard stove burner.

2. Omelet Pan as claimed in claim 1 wherein said gears include a plurality of mating spur gears, the last of which terminate in a miter gear so that a mating miter gear and attached pinion can roll on a slidable rack where said rack terminates in said flipper activation tab, the activation tab terminating in a compression spring so that when a person pulls back on said activation tab, said gears cause said flipper engagement post and attached flipper to rotate thereby causing a flipping action that facilitates the cooking of an omelet or crepe.

3. An alternated embodiment of said omelet pan as claimed in claim 1 wherein the portion of said pan side wall that corresponds to said depressed portion is cut away to allow a specially designed spatula to slip under a cooked omelet or crepe for easy removal from said pan.

4. Omelet Pan as claimed in claim 1 further comprising a lid that fits snuggly within the top perimeter of said pan, said lid including a centrally located knob for removing or replacing said lid.

5. Omelet Pan as claimed in claim 1 further comprising an alternate version of said omelet pan that employs only one flipper rather than the two opposing flippers previously described.

6. Omelet Pan as claimed in claim 1 wherein the portions of said pan that are under said flipper members are recessed to that when said flipper members are in their rest position, the top surface of said flippers and the flat surface at the interior of said pan are at the same level.

7. An alternate embodiment of said omelet pan as claimed in 1 wherein a single flipper folds said omelet roughly in half making a more traditionally shaped omelet.
